(19) United States
(12) Patent Application Publication
(10) Pub. No.: US 2018/0184632 A1
(43) Pub. Date: Jul. 5, 2018

(54) A DEVICE FOR USE IN SEA FISHING

(71) Applicant: OPEN OCEAN TACKLE LTD, Cambridge (GB)

(72) Inventor: Jason PIPE, London (GB)

(21) Appl. No.: 15/741,436

(22) PCT Filed: Jun. 30, 2016
(86) PCT No.: PCT/EP2016/065276

§ 371 Date: Jan. 2, 2018

(30) Foreign Application Priority Data
Jul. 3, 2015 (GB) 1511746.8

(51) Int. Cl. A01K 89/015; A01K 89/08; A01K 97/04; A01K 97/10

(52) U.S. Cl. CPC A01K 89/01925; A01K 89/08; B63B 35/14; A01K 97/10; A01K 97/04

(57) ABSTRACT

The invention provides an apparatus for the temporary storage of a length of a fishing line, the apparatus comprising:

a support plate 6;

a drum 4, about which a length of the fishing line can be wound, the drum 4 being non-rotatably mounted on the support plate and having a proximal end 4a and a distal end 4b wherein the drum 4 is secured to the support plate 6 at its proximal end 4a;

at least one retaining element 28, 30 for releasably holding a section of the fishing line; and a mounting arm pivotably 8 connected to the support plate 6.

This invention relates to a device for use in sea fishing and in particular fishing for large game fish such as tuna and marlin.

### BACKGROUND OF THE INVENTION

Trolling is a method of fishing in which fishing lines baited with live or dead bait fish or artificial bait fish (commonly known as lures) are trailed behind a boat in order to attract and catch fish. In one variant of the trolling method, a line baited with a lure is used to entice the fish near to the boat and then the lure is removed from the water and a line carrying a hook and live or dead bait pitched into the water in its place. This technique is often referred to as bait and switch.

If, when striking at and swallowing a bait fish, a fish senses tension in the fishing line, it will often immediately regurgitate the bait fish before the hook has set, with the result that the catch is lost. In order to prevent the fish from feeling tension in the line and rejecting the bait, a length of slack line can be created so that the fish can swim away with the bait (and line) before the length of slack line runs out and the consequent jolt (or strike) sets the hook into the fish.

Experienced fishermen may create slack line by setting the fishing rod to free spool while using their thumb to stop the spool from spinning too fast and the line from tangling. This will typically involve the rod being held in one hand so that it points upwards with the reel being at around shoulder height and the thumb of that hand being used to control the speed of rotation of the spool. The line is held in the other hand. Although this method is suitable for experienced fishermen, it is less suitable for more inexperienced fishermen. It is also difficult to perform with heavy tackle where, for example, the reels used to carry 130 lb breaking strain line can weigh as much as 5 kg.

Numerous devices have therefore been developed that automatically release a predetermined length of slack line following the initial strike by the fish.

U.S. Pat. No. 2,864,199 A1 discloses a device where a length of line is automatically released upon a fish striking the bait. The fishing line is wrapped around a spool, when the spool is in a position where the line is not free to run. When the line is tensioned by a strike, the spool is rotated by 90° to a position where it is free to unwind from the spool. However, in order to release the stored length of line, the line must unwind around the spool. With this, there is the chance that the fish will be able to feel the friction and tension in the line, causing it to release the bait, resulting in an unsuccessful catch.

U.S. Pat. No. 3,136,086 A1 discloses an automated line releasing device wherein a length of line is wrapped around 2 pins and then linked to a trigger device. Once the fish strikes the bait, the trigger device is activated and releases the line, allowing the pre-loaded length of line to be released from the pins.

U.S. Pat. No. 3,500,575 A1 discloses a device which automatically releases a length of fishing line. The line is wrapped around a conical body having a groove or grooves around its circumference and is held by a clip located at the end of the conical body. When the fish strikes the bait, the line is released from the clip, so that the bait appears stationary to the fish. However the presence of grooves would provide friction and resistance when the line is being released from the body and it is likely that the fish would feel the resistance and therefore release the bait, leading to an unsuccessful catch.

U.S. Pat. No. 3,629,966 A1 discloses a line storage device placed adjacent a standard reel, which stores a length of line that is automatically released upon application of a predetermined tension on the line.

U.S. Pat. No. 5,239,769 A1 discloses a spool suitable for mounting in a fishing rod holder, which automatically releases a length of line once the fish has struck the bait. The line is wound around the spool and attached to a supporting rod by a clip. On release of the line, however, there is likely to be a resistance associated with the rotation of the spool, which could lead the fish to spit out the bait.

WO 99/65297 A1 discloses a fishing device with means for retaining a section of line to enable the line to feed out when a strike of the bait occurs. The device comprises a cone around which the line is wound. As with the above devices, when the line is released, it must unwind around the conical spool. The friction resulting from this could lead to the fish releasing the bait before the hook sets.

Many of the foregoing devices comprise a spool around which the length of line is wrapped and a clip which prevents the line from unravelling until the fish strikes the bait. These devices suffer from the drawback that the fish is likely to feel the resistance resulting from either the friction of the line against the spool body or the rotation of the spool itself and will therefore release the bait before the hook has caught.

Moreover, many of these devices are intended to be fitted to fishing boat via clamp or bracket type arrangements which make it difficult for the device to be moved to different locations on the boat, especially while the boat is in motion, and their fixed arrangements limit the locations in which they can be effectively used.

### THE INVENTION

The invention addresses the abovementioned problems by providing an apparatus that allows a predetermined, stored length of line to be released in such a way that substantially no resistance is experienced by the fish when it takes the bait. The fish will therefore swallow the bait and swim away with the hook and bait until the length of slack line runs out and the consequent jolt sets the hook into the fish.

Additionally, the apparatus is capable of being quickly and easily moved around a boat and the orientation of the apparatus varied so that it is suitable for use in a wide variety of locations around the boat.

In a first aspect of the invention, the invention provides an apparatus for the temporary storage of a length of a fishing line, the apparatus comprising:

a support plate;

a drum, about which a length of the fishing line can be wound, the drum having a proximal end and a distal end wherein the drum is secured to the support plate at its proximal end;

at least one retaining element for releasably holding a section of the fishing line; and

a mounting arm pivotably connected to the support plate.

The apparatus can be used to temporarily store a length of fishing line, thereby avoiding the need for free-running a fishing rod reel.

The support plate may have an elongate slot, suitable for use as a carry handle. The slot may be straight or curved. In one embodiment the slot is shaped as a rounded oblong and is large enough to accommodate 2 or more fingers, preferably 3 or more fingers, even more preferably 4 or more fingers or even more preferably a whole hand. The slot may also contain 2 or more finger grooves, preferably 3 or more or more preferably 4, along its top edge to allow comfortable and easy carrying.

The drum may have a circular, elliptic or polygon-shaped, but typically circular, cross-section. In one embodiment the drum is cylindrical in shape. The drum may be hollow, partially hollow or solid.

In one embodiment, the drum is mounted non-rotatably on the support plate.

The drum may comprise an end plate, which forms the distal end of the drum and a hollow tubular body, which forms the body of the drum. The assembly of the end plate, tubular body and support plate may be connected together by suitable securing means. For example, a shaft having at least one threaded end may extend from the end plate through the centre of the body of the drum and through a hole in the support plate, where it can be secured with a nut.

The support plate has first and second faces (which may be referred to for convenience herein as front and rear faces respectively). On the first face is mounted the drum and to the second face is attached the mounting arm. The end of the drum and the support plate may be provided with inter-engaging formations (for example co-operating grooves, recesses, ridges and protrusions) that hold the drum in position on the support plate. In one embodiment there is a groove or recess in the support plate, in which the circumferential edge of the hollow tubular body is received.

At its distal end, the drum may have a circumferential or part-circumferential, radially outwardly extending wall to prevent inadvertent dislodging of the fishing line from the end of the drum. The wall may be continuous or discontinuous. In one embodiment, the wall takes the form of a circumferential continuous, radially outwardly extending flange.

The body of the drum may have grooves or indentations around its circumference. These grooves typically have smoothed edges and usually have a depth of less than half of the diameter of the fishing line used. The grooves are formed such that they do not snag or cause friction or tension in the line, as the line is being unwound from the drum.

The apparatus contains at least one, for example two, retaining elements, to hold the fishing line in place. The retaining elements may be secured to the support plate.

The retaining elements may take the form of clips. The clips may be hinged or resiliently biased to allow a length of fishing line to be inserted and protected from being inadvertently released. In one embodiment the clip is formed from two arms that are shaped so that the two sections of the arms in are in contact with one another. The arms are made of a suitably pliable and resilient material (for example a plastics material) so that the two arms can be prised apart to allow insertion of the line. Once the line has been inserted, the arms revert to their original closed position, to prevent the line from being released.

In one embodiment, the retaining element(s) take the form of clips, each clip having a pair of arms configured to be movable between a closed position, in which the fishing line can be held between the arms, and an open position in which the fishing line when present can be released from the arms. Each clip may be configured to provide a restoring force for moving the arms back from the open position to the closed position. Accordingly, at least one of the arms may be formed from a resilient material. In one particular embodiment, both arms are formed from a resilient material.

The clips may each have a tail section which can be attached to the support plate. For example, the tail section can be threaded to engage a correspondingly threaded hole in the support plate.

In one embodiment, the clips comprise an integrally formed pair of arms and a tail section. For example, the clips can be moulded as unitary items from a plastics material.

Use of the clips is advantageous in that it provides better control in releasing a length of the line, as will be apparent from the description and drawings below.

The mounting arm may be mounted via a bracket to the support plate to allow pivoting movement. The bracket may have two limbs and be substantially “L-shaped”.

In one embodiment, the mounting arm may be connected to the support plate by means of a shoulder piece. The shoulder piece may be mounted on the support plate via the bracket. The attachment between the shoulder piece and bracket can be adjustable to allow the mounting arm to pivot relative to the rear face of the support plate.

At least the lower part of the mounting arm may be configured so that it can be held in a socket. Suitable sockets are the conventional rod holders found on fishing boats. Therefore, in one embodiment, the mounting arm is configured so as to be receivable in a tubular rod holder.

The mounting arm may be provided with a foot piece having a configuration that engages with a complementary formation located at the base of the socket, for example to prevent rotation of the mounting arm in the socket. For example, the foot piece may have a recess (e.g. a cross-shaped groove) or protrusion that can engage with a complementary protrusion (e.g. a cross-shaped protrusion) or recess at the base of the socket.

This arrangement has the advantage that the apparatus can easily be lifted out of, moved between and inserted into various rod holders of a boat. Therefore, the mounting arm can be mounted securely and with relative ease at numerous positions around the fishing boat. Additionally, once a fish has been hooked, the device can easily be cleared away and stored to provide more space on deck.

The apparatus may be formed from metals such as aluminium, stainless steel or corrosion resistant material, plastics, carbon fibre and combinations thereof. In one embodiment, the drum is formed from carbon fibre and the support plate and mounting arm are formed from aluminium. In another embodiment the drum, support plate and mounting arm are all formed from aluminium.

In a second aspect of the invention, the invention provides an apparatus for the temporary storage of a length of fishing line comprising:

a drum about which a length of fishing line can be wound; and

a mounting arm pivotably connected to the drum.

The drum and mounting arm may be as described above.

In a third aspect, the invention provides an apparatus comprising:

an apparatus as described in the first or second aspects above;

a socket; and

securing elements to allow the socket to be mounted onto a fixed structure.

The socket may be tubular in shape with a base. At the base, inside the socket there may be a locating element which engages with a formation on or at the base of the mounting arm. The locating element typically engages with the formation on or at the base of the mounting arm to prevent rotation of the mounting arm. For example, the socket may have a protrusion (e.g. a cross-shaped protrusion) or a recess, which complements a recess (e.g. a cross-shaped groove) or protrusion on the base of the mounting arm.

The securing elements may take the form of brackets. A suitable bracket may comprise a base element containing a number of holes, through which screws can be used to secure the base element to a flat surface on the fixed structure. Secured to the exposed side of the base element may be shaft attached to the socket.

Alternatively, the bracket could take the form of a “U-shaped” bracket, where the ends of the bracket can be attached to the fixed structure and the bracket acts as a collar or a sleeve around the circumference of the socket to hold it securely in place.

The fixed structure may be a fishing chair.

In a fourth aspect, the invention provides a fishing chair comprising:

a first socket having mounted therein a device according to any one of the preceding claims;

securing elements to allow the first socket to be mounted to the chair; and optionally

a tubular container in which bait can be kept; and/or

a second socket, in which a fishing rod can be mounted.

The sockets and securing elements may be as described above.

The tubular container in which the bait can be kept may have a tubular body with a closed base and be attached to the chair via similar means to the above socket.

Further aspects and embodiments of the invention will be apparent from the claims appended hereto and the apparatus illustrated in the drawings and described below.

### BRIEF DESCRIPTION OF THE DRAWINGS

FIG. 1 is a front view of the apparatus.

FIG. 2 is a view from the rear and to one side of the apparatus with the retaining clips removed.

FIG. 3 is a view from the rear and to the other side of the apparatus with the retaining clips removed.

FIG. 4 is a top view of the apparatus.

FIG. 5 is a cross-sectional view of the apparatus

FIGS. 6 and 7 shows a fishing chair fitted with the apparatus of FIGS. 1 to 5.

### DETAILED DESCRIPTION OF THE INVENTION

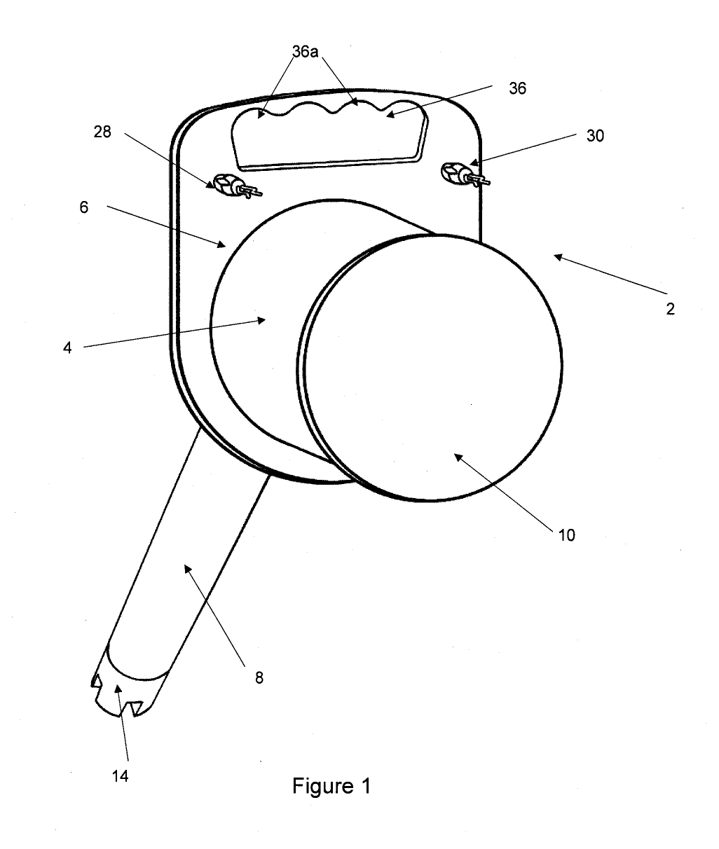

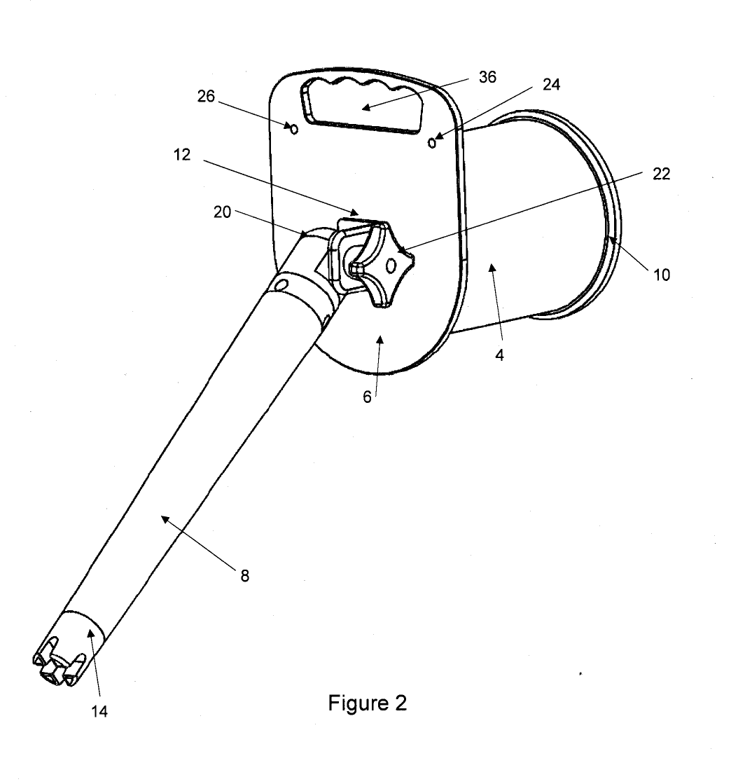

The invention will now be illustrated but not limited by reference to the specific embodiments shown in the drawings FIGS. 1 to 7.

As shown in FIGS. 1 to 5, according to one embodiment of the invention apparatus 2 comprises a drum 4 and a support plate 6 mounted upon a mounting arm 8.

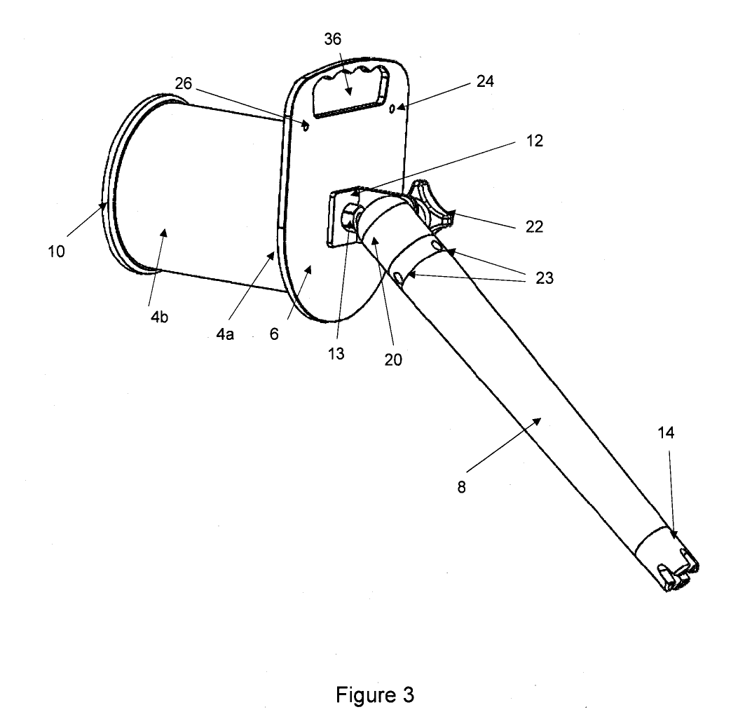

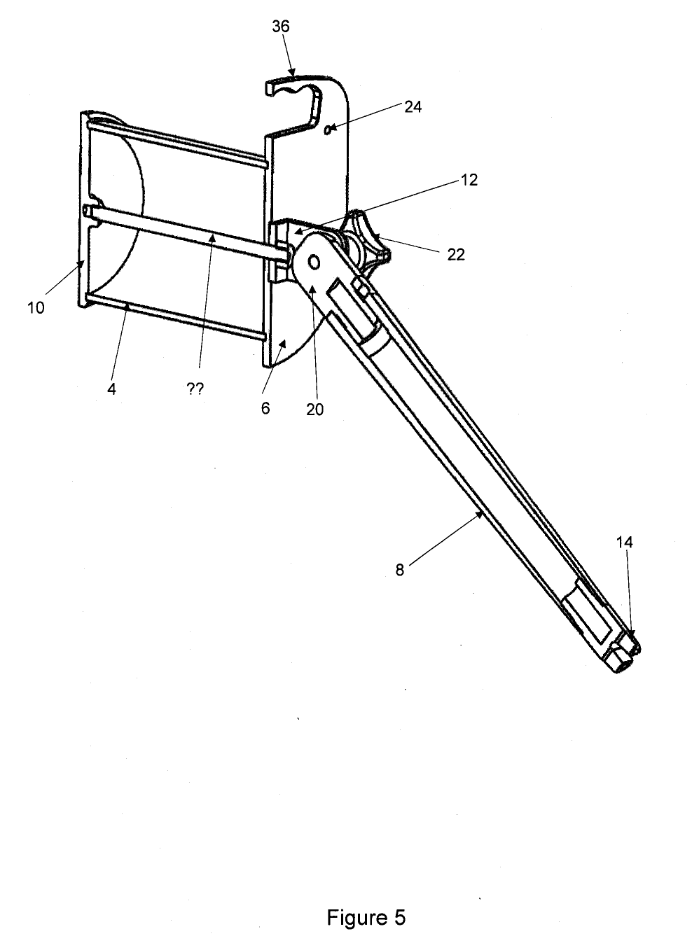

Drum 4 is cylindrical in shape and has of a proximal end 4a (see FIG. 3), to which support plate 6 is attached, and a distal end 4b. A threaded shaft extending from the distal end of the drum through its hollow body then passes through holes in support plate 6 and bracket 12 to allow these three components to be secured together by a nut 13 (see FIG. 5).

The distal end of the drum 4b has a radially, outwardly extending circumferential flange 10 with a larger diameter than the body of the drum itself. Circumferential, radially outwardly extending flange 10 prevents the stored line from inadvertently sliding off the end of the drum, but is small enough to allow the line to unravel off the end of drum 4 so not to cause significant friction in the line when the user wishes to release the line after the fish has caught the bait.

Bracket 12 is “L-shaped” and one limb of the bracket is attached to the support plate 6 as described above and the other arm has a hole through which the mounting arm 8 can be secured.

Mounting arm 8 is of tubular construction and has a profile selected so that it can be inserted into various pole or rod holders around a fishing boat. The pole or rod holders may be located adjacent or on the user's fishing chair or on the deck or gunwale of the boat.

To the end of the arm remote from the support plate is attached a foot piece 14 having a cross-shaped slot engageable with a complementary formation in the pole or rod holder.

At its upper end, the mounting arm 8 is provided with a shoulder piece 20. The shoulder piece has a spigot formation which is secured in place inside mounting arm 8 by means of a one or more grub screws 23 through the wall of the mounting arm 8.

Extending from a flat face of the shoulder piece 20 is a threaded shaft (not shown), which extends through a hole in bracket 12 and is secured by an internally threaded knob 22. The angle between mounting arm 8 and support plate 6 may be adjusted by loosening knob 22, adjusting the angle between the two components and retightening knob 22 to hold support plate 6 and mounting arm 8 in the desired position.

The support plate 6 has two threaded holes, 24 and 26, both located above drum 4, into which clips 28 and 30 are screwed.

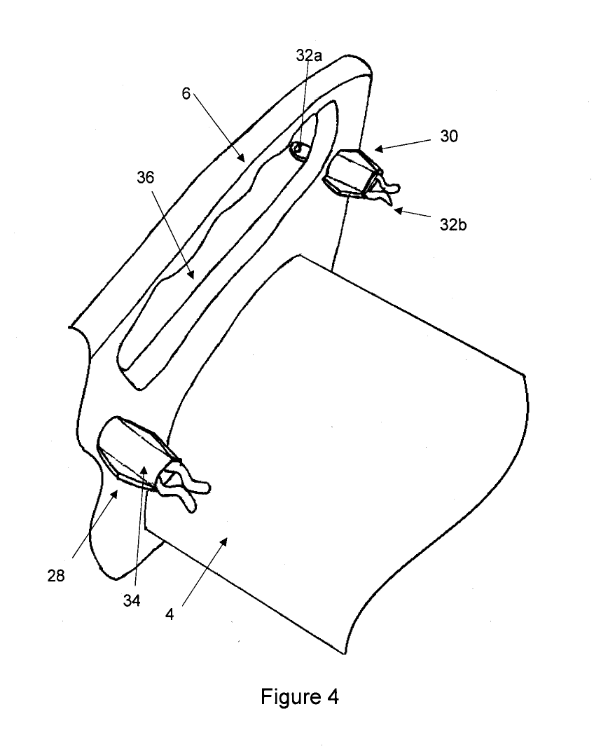

As shown in FIG. 4, each clip 28 and 30 comprises an insert 32, with a threaded tail section 32a and two resilient arms 32b, and a sleeve 34. Both of the two arms are bent in such a way as to form an “S-shape”. The tail of insert 32 is threaded through the sleeve before being screwed into the threaded hole 24 or 26 in support plate 6. When inserted, the sleeve fits tightly around the insert so that the two “S-shaped” arms are in contact with each other to prevent the line from falling out of the clip, unless the user applies sufficient force on the line to separate the arms.

The support plate 6 has a slot 36, of a sufficient size to accommodate a user's hand, which may be used as a carry-handle to allow for easy transportation of the apparatus. The slot is generally of a rounded-oblong shape, with four grooves 36a on its upper edge to accommodate each of the user's fingers to assist with carrying the apparatus.

In the embodiment shown, the drum 4 is formed from carbon fibre or aluminium and the support plate 6 and mounting arm 8 are constructed from aluminium. It will be appreciated however that other durable and generally corrosion resistant materials such as plastics, stainless steel and other corrosion resistant metals and alloys may be used instead.

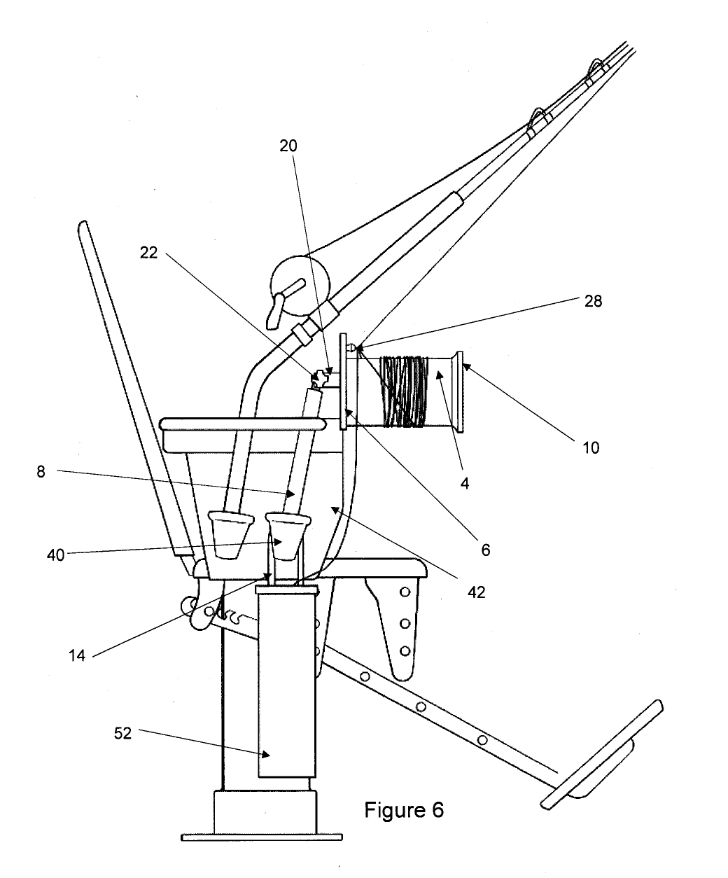

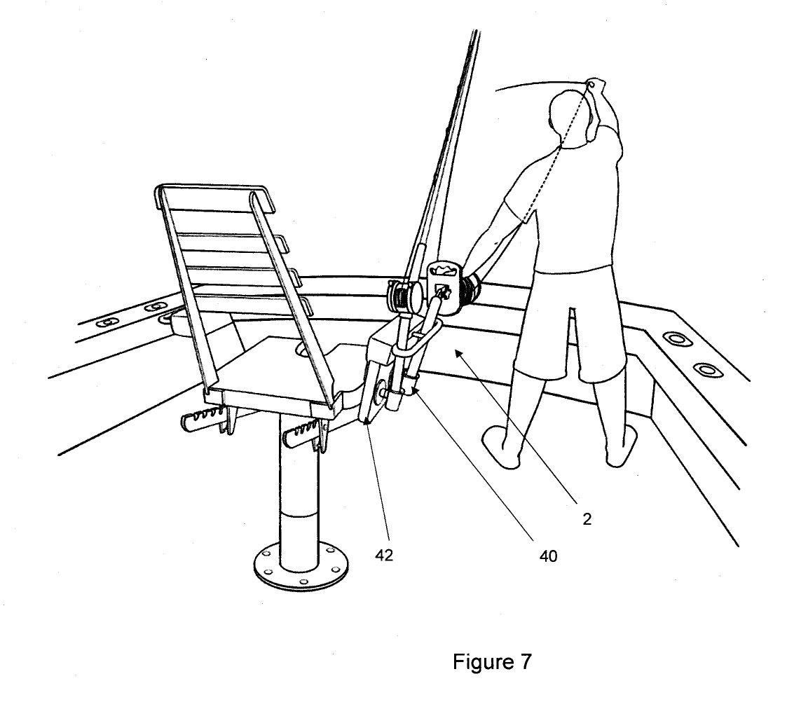

FIGS. 6 and 7 show a fishing chair fitted with the apparatus for the temporary storage of a length of fishing line as described above. The mounting arm 8 is held in a socket 40. The socket comprises a tubular body with a closed lower end, the opening of the tubular body being of a diameter large enough to receive the mounting arm 8. The socket is secured to a side plate 42 located at the side of the chair, underneath one of the arm rests.

In the embodiment illustrated, the chair is provided with a container 52 for holding a baited hook. The container 52 has a tubular body with a closed base and hangs via a looped element around an arm (not shown) connecting the socket 40 to the side plate 42.

In use a length of line is unwound from the reel of a fishing rod and a section of the line close to the end of the fishing rod is held in clip 30. The excess length of free line (e.g. approximately 70m) is then wrapped around the body of drum 4 before being clipped in clip 28 to prevent premature unravelling. The free end of the line is then attached to a hook, such as a circle hook, and the drag on the reel on the road is set to a low drag setting. A suitable bait is then attached to the end of the hook and the baited hook is stored in the container 52 which is filled with water.

Once a fish has been sighted and lured in, the line is disengaged from clip 28 and the baited hook is pitched into the water. A length of the pre-stored length of line can then be released in a controlled manner. Once a desired length of the line has been released, the user can prevent further releasing of the line by placing his palm on the outer face of the flange 10 and holding the line between thumb and forefinger.

When the fish is judged to have taken the bait, the user will release the line from between his thumb and forefinger to allow the remainder of the stored line to be released from the drum with no resistance. This “free”-release of the line means that the fish will not detect any tension in the line before swallowing the hook.

Once the fish has swallowed the hook any excess line can be taken up on the rod and any further tension applied to the line will cause the hook to set in the mouth of the fish.

During release of a length of the fishing line by the user, the user can, after having released a certain length of line, reattach the line to one of the clips. This allows a length of the line to be reserved on the spool.

It will readily be apparent that numerous modifications and alterations could be made to the invention illustrated in FIGS. 1 to 7 without departing from the principles underlying the invention and all such modifications and alterations are intended to be embraced by this application.

1. An apparatus for the temporary storage of a length of a fishing line, the apparatus comprising:
a support plate;
a drum, about which a length of the fishing line can be wound, the drum being non-rotatably mounted on the support plate and having a proximal end and a distal end wherein the drum is secured to the support plate at its proximal end;
at least one retaining element for releasably holding a section of the fishing line; and
a mounting arm pivotably connected to the support plate.

2. An apparatus according to claim 1 comprising two retaining elements.

3. An apparatus according to claim 2 wherein the retaining element(s) are attached to the support plate.

4. An apparatus according to claim 2 wherein the retaining element(s) take the form of clips, each clip having a pair of arms configured to be movable between a closed position, in which the fishing line can be held between the arms, and an open position in which the fishing line when present can be released from the arms.

5. An apparatus according to claim 4 wherein each clip is configured to provide a restoring force for moving the arms back from the open position to the closed position.

6. An apparatus according to claim 5 wherein at least one of the arms is formed from a resilient material.

7. An apparatus according to claim 6 wherein both arms are formed from a resilient material.

8. An apparatus according to claim 1 wherein the drum comprises an end plate, which forms the distal end of the drum and a hollow tubular body, which forms a body of the drum.

9. An apparatus according to claim 1 wherein the drum is formed from carbon fibre and the support plate and mounting arm are formed from aluminium.

10. An apparatus according to claim 1 wherein the drum has a radially outwardly extending flange around the circumference of its distal end.

11. An apparatus according to claim 1 wherein the drum is cylindrical.

12. An apparatus according to claim 1 wherein the support plate has a slot for use as a carry handle.

13. An apparatus according to claim 1 wherein the mounting arm is mounted via a bracket on the support plate to allow for pivoting movement.

14. An apparatus according to claim 1 wherein the mounting arm is receivable in a tubular rod holder.

15. An apparatus as described in claim 1 in combination with
a tubular socket and one or more securing elements to allow the tubular socket to be mounted on a fixed structure.

16. An apparatus according to claim 15 wherein there is a locating element inside the socket which engages with a formation on the base of the mounting arm.

17. (canceled)

18. A fishing chair comprising:
a first socket having mounted therein an apparatus according to claim 1;
one or more securing elements to allow the first socket to be mounted on the chair; and
optionally
a tubular container in which bait can be kept; and/or
a second socket, in which a fishing rod can be mounted.

19. A fishing chair according to claim 18 comprising a first socket having mounted therein an apparatus according to claim 1 wherein the apparatus comprising two retaining elements.

20. A fishing chair according to claim 18 comprising a first socket having mounted therein an apparatus according to claim 1 wherein the drum has a radially outwardly extending flange around the circumference of its distal end.

21. A fishing chair according to claim 18 comprising a first socket having mounted therein an apparatus according to claim 1 wherein there is a locating element inside the first socket which engages with a formation on the base of the mounting arm.
